(19) United States
(12) Patent Application Publication
(10) Pub. No.: US 2002/0082899 A1
(43) Pub. Date: Jun. 27, 2002

(54) Methods and systems for integrating marketing, production, and finance

(76) Inventor: Fredrick J. Aley, Redding, CT (US)

Correspondence Address: John S. Beulick, Armstrong Teasdale LLP, Suite 2600, One Metropolitan Square, St. Louis, MO, 63102-2740, US

(21) Appl. No.: 09/747,862

(22) Filed: Dec. 22, 2000

Related U.S. Application Data
(60) Provisional application No. 60/237,108, filed on Sep. 29, 2000.

(51) Int. Cl. G06F 17/60

(52) U.S. Cl. 705/10

(57) ABSTRACT

A multi-year integrated marketing, production and financial system for use in a manufacturing business is disclosed. The system is configured with a plurality of spreadsheets to integrate a multi-year market forecast for all products produced with production specifications, production and performance parameters such as capacity, efficiency, waste levels, materials, utilities and labor cost, and production scheduling. The system further provides for unit or brand costing, including all fixed and variable financial aspects of the business and instantly shows impact to Earnings Before Interest, Taxes, Depreciation and Amortization (EBITDA) from even the slightest change to any parameter in marketing, finance, or production.

### CROSS REFERENCE TO RELATED APPLICATIONS

This application claims the benefit of U.S. Provisional Application No. 60/237,108, filed Sep. 29, 2000, which is hereby incorporated by reference in its entirety.

### BACKGROUND OF THE INVENTION

This invention relates generally to manufacturing, and more specifically to systems and methods used to integrate functions within a manufacturing business.

Operation of a large scale manufacturing business requires informed decision making by the decision makers operating the business. However, the decisions of the decision makers are only as accurate as the information with which they are supplied. In a manufacturing business, many individual functions are reporting to the decision makers, for example, a purchasing manager is the person most likely to have material cost information. However regarding material cost, an accounts payable person may have different information with respect to material costs. As an example, the purchasing manager may have received a discount on a particular purchase, where the accounts payable person would consider the price paid the normal non-discounted price.

Problems also occur because the individual reporting functions within the business may have a narrow view of the business. Business data received from such business function may tend to be narrowly focused and not take into account other functions which can affect the data reported. It would be desirable to integrate business functions such as materials, sales, marketing, production and finance, to name a few, into one system where received data with respect to one business function is analyzed with respect to other received business data.

### BRIEF SUMMARY OF THE INVENTION

In one aspect, the present invention is a multi-year integrated marketing, production and financial system for use in a manufacturing business. The system is configured with a plurality of spreadsheets to integrate a multi-year market forecast for all products produced with production specifications, production and performance parameters such as capacity, efficiency, waste levels, materials, utilities and labor cost, and production scheduling. The system further provides for unit or brand costing, including all fixed and variable financial aspects of the business and instantly shows impact to Earnings Before Interest, Taxes, Depreciation and Amortization (EBITDA) from even the slightest change to any parameter in marketing, finance, or production.

### BRIEF DESCRIPTION OF THE DRAWINGS

FIG. 1 is a block diagram of a system;

FIG. 2 is a flowchart which describes data input and operation of the system;

FIG. 3 is an example spreadsheet showing business parameters that are input into the system;

FIG. 4 is a spreadsheet which documents supply costs;

FIG. 5 is a spreadsheet which details utility costs as a function of product production;

FIG. 6 is a spreadsheet which shows profit and loss by product brand codes;

FIG. 7 is a spreadsheet of Earnings Before Interest, Taxes, Depreciation or Amortization (EBITDA);

FIG. 8 is a spreadsheet used to develop production forecasts;

FIG. 9 is a spreadsheet which contains product specifications and performance standards;

FIG. 10 is a spreadsheet of labor costs;

FIG. 11 is a production capability spreadsheet;

FIG. 12 is a rolling forecast spreadsheet which shows per product outputs against machine capacities;

FIG. 13 is a graph generated to show product cost break down by percentages;

FIG. 14 is a graph generated to show product profit margin; and

FIG. 15 is a graph generated to show variable contribution for each product brand.

### DETAILED DESCRIPTION OF THE INVENTION

One exemplary embodiment of systems and methods that facilitate integrated marketing, production and financial management related to a manufacturing business are described below in detail. The systems and processes facilitate, for example, electronic submission of information, automated extraction of information, and assessment reporting and management of the manufacturing business for system users. The systems and processes are not limited to the specific embodiments described herein. In addition, components of each system and each process can be practiced independent and separate from other components and processes described herein. Each component and process can be used in combination with other components and processes.

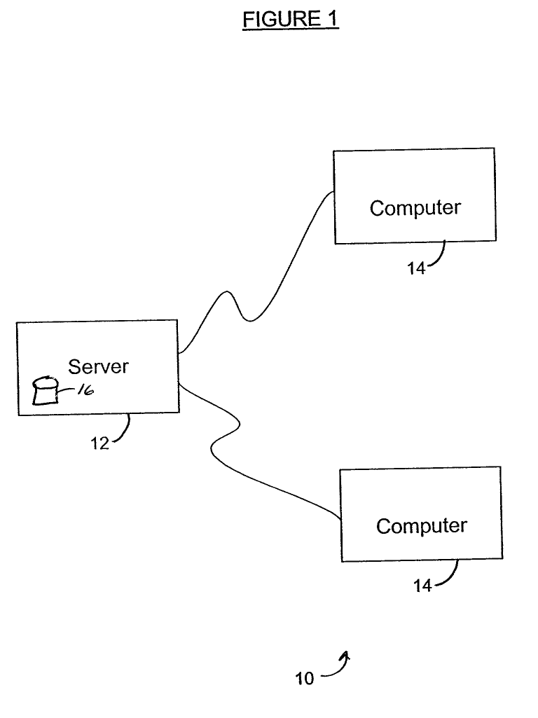

More specifically, FIG. 1 is a simplified block diagram of a marketing, production and financial system 10 including a server 12 and a plurality of computers 14 configured as client systems and connected to server 12. In one embodiment, computers 14 include a web browser, and server 12 is accessible to computers 14 via the Internet. In addition, server 12 is a computer. Computers 14 are interconnected to the Internet through many interfaces including a network, such as a local area network (LAN) or a wide area network (WAN), dial-in-connections, cable modems and special high-speed ISDN lines. In another embodiment, the network is an intranet. Computers 14 could be any device capable of interconnecting to the network including a web-based phone or other web-based connectable equipment, including wireless web and satellite. Server 12 includes a database 16 of spreadsheets containing marketing, production and financial information on multiple businesses, as described below in greater detail, and can be accessed by registered users at one of computers 14 by logging onto server 12 through one of computers 14. In an alternative embodiment, system 10 is implemented as a mainframe computer with a plurality of terminals. In addition, the methods described herein can be implemented on a stand-alone computer.

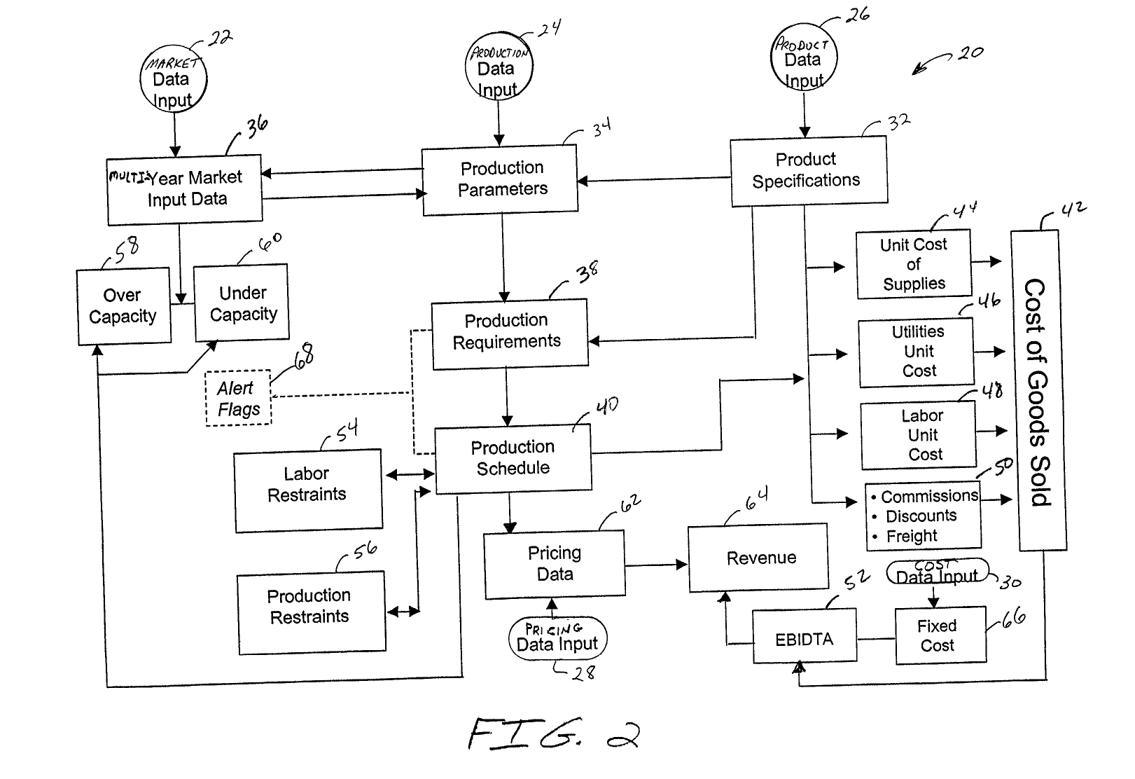

FIG. 2 is a flowchart 20 diagramming operation of system 10. System 10 is configured to receive multiple types of data input required for generation of marketing, production and financial data. Data inputs include marketing data 22, production data 24, product data 26, pricing data 28, and cost data 30. The example described herein pertains to the paper and paper milling industry. Initial base data is entered into the program which, for the paper industry includes both production parameters and product specifications for each brand produced. Such initial base data, for example, product data input 26, typically includes such items as basis weight, sheet size, sheet count, roll count and case count and are input and stored at product specifications 32. Operating speeds and efficiencies and waste levels are initially entered as production data inputs 24 and stored as production parameters 34. Production parameters 34 also include, for example, maximum days available for production in any given month, crew size, and hours available per shift of operation.

After the initial base data is entered, a marketing forecast is entered as market data 22, by product and by month for the first year, and then by year for a remaining number of years. Marketing data is stored as multi-year market data 36. Storing of marketing data initiates analysis that compares the market forecast with actual production capabilities, production requirements 38, product specifications 32 and costs. The results of the analysis are reflected in production scheduling 40, costs of goods sold 42, which includes a per unit breakdown of supply costs 44, utilities per unit cost 46, labor per unit cost 48 and any commissions, discounts and freight 50, and additionally, profitability. In one example, change in market data 36 that is entered into system 10 is immediately reflected in a change in cost of goods sold 42 and further, a change in EBITDA 52.

Direct Labor cost or labor per unit cost 48 is applied to the smallest unit of production based on the actual time required to produce that unit, taking into account all of the production parameters 34 and production specifications 32 provided. Material cost or supply costs 44 are also applied to the smallest unit of production based on product specifications 34. Utility cost is first allocated to fixed and variable and by method (usage rates) of production and time to produce each unit and is referred to as utilities per unit cost 46. All costs are allocated in a manner to represent the true cost of production for each product. (unit cost). Sales discounts, freight, commissions 50 and other costs are also allocated by brand and reflected in the per unit cost.

Variables that can affect production schedule 40, and therefore cost of goods sold 42 include labor restraints 54 and production restraints 56. In addition, by examining production schedule 40 and multi-year market data 36, which take into account production parameters 34 and product specifications 32, an over capacity 58 or under capacity 60 for production can be ascertained by a scheduling analysis by shift to illustrate over capacity or under capacity situations. The scheduling analysis allows the user to build in bottlenecks of production where it red-flags critical situations that result from a Marketing Forecast, a production scheduling change, a product specification change or a production capability situation as described below.

Pricing data 62 is obtained by looking at pricing data input 28 and production schedule 40 which, as described above, takes into account costs contained in labor restraints 54 and production restraints 56. Pricing data 62 is one element of revenue 64, which is also influenced by manually input cost data input 30 which supplies system 10 with fixed costs 66 from which EBIDTA 52 is obtained. Pricing data 62 and EBIDTA 52 are used to determine revenue 64. System 10 is also configured with alert flags 68 which are inputs to production schedule 40 and production requirements 38. Alert flags 68 are used to notify system 10 of unexpected events, for example, a conflict in availability of resources such as manpower or equipment, which would have a significant impact on production schedule 40 and production requirements 38.

Use of system 10, described above, allows a salesman in the field, for example, to immediately know any impacts to production and finance of a change in either pricing, commissions, freight, product specification, sales volumes or sales forecasts of a production item. Further, system 10 is extremely useful for “what-if” analysis to determine impact on scheduling or cost of manufacturing for a marketing change or vice versa. System 10 is configured to extract profitability by brand to enable management focus on non-profitable or less profitable products through margin contribution.

In one preferred embodiment, the application as described in flow chart 20 is developed as an application under Microsoft Excel™. Microsoft Excel is a trademark of Microsoft Corporation, Redmond, Wash. In addition, the application incorporates a revision log for incorporating a listing of all changes and revisions to the spreadsheets by date. In the preferred embodiment, the application is divided into eight integrated spreadsheets including Marketing Forecast, Production, Product Specifications, Shifts of Operation, Labor, Supplies, Fixed Cost, Utilities, Profit/Loss and EBITDA. In another preferred embodiment, various customizable charts are provided for graphical analysis. Any customized chart generated for specific analysis as desired is contemplated.

Each spreadsheet listed above contains data entry fields which are described in some detail below. All non data entry fields, or calculation/formula fields, are grayed out and not accessible without an assigned password. A user with an appropriate password can display and edit all formulas and algorithms. The spreadsheets use look-up tables to access cost data and product information. Costs are calculated on a per unit basis to accurately determine margin contribution for each product. Brand Cost and Profit margin by brand is also depicted graphically.

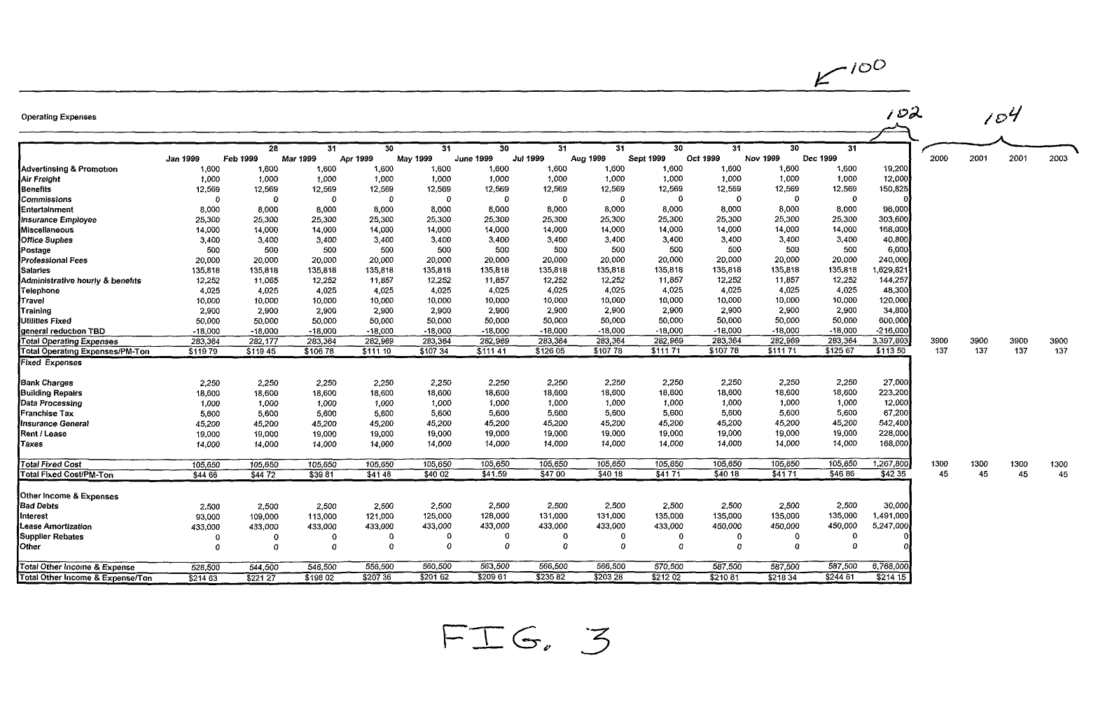

FIG. 3 is a spreadsheet 100 according to the present invention, stored within system 10 (shown in FIG. 1), which contains data entry fields for a businesses' operating and fixed expenses on a monthly basis. Examples of operating expenses shown in FIG. 3 include advertising & promotion, air freight, benefits, commissions, entertainment, insurance employee, miscellaneous, office supplies, postage, professional fees, salaries, administrative hourly & benefits, telephone, travel, training, fixed utilities, general reduction which are automatically added to determine total operating expenses. Based upon paper production quantities which are described later, spreadsheet 100 is also configured to determine total operating expenses per metric-ton of product produced. Examples of fixed expenses shown in FIG. 3 include bank charges, building repairs, data processing, franchise tax, insurance general, rent/lease and taxes which are automatically added to determine total fixed expenses. Similar to operating expenses described above, spreadsheet 100 is also configured to determine total fixed expenses per metric-ton of product produced. Other incomes and expenses are included in spreadsheet 100 which are totaled and divided out over unit cost, in the example described per metric ton, include bad debts, interest, lease amortization, supplier rebates and other.

Spreadsheet 100 is further configured to total the monthly entries to supply the items described above as a yearly number as shown in column 102, which allows an authorized user to enter numbers for the following years as shown in columns 104.

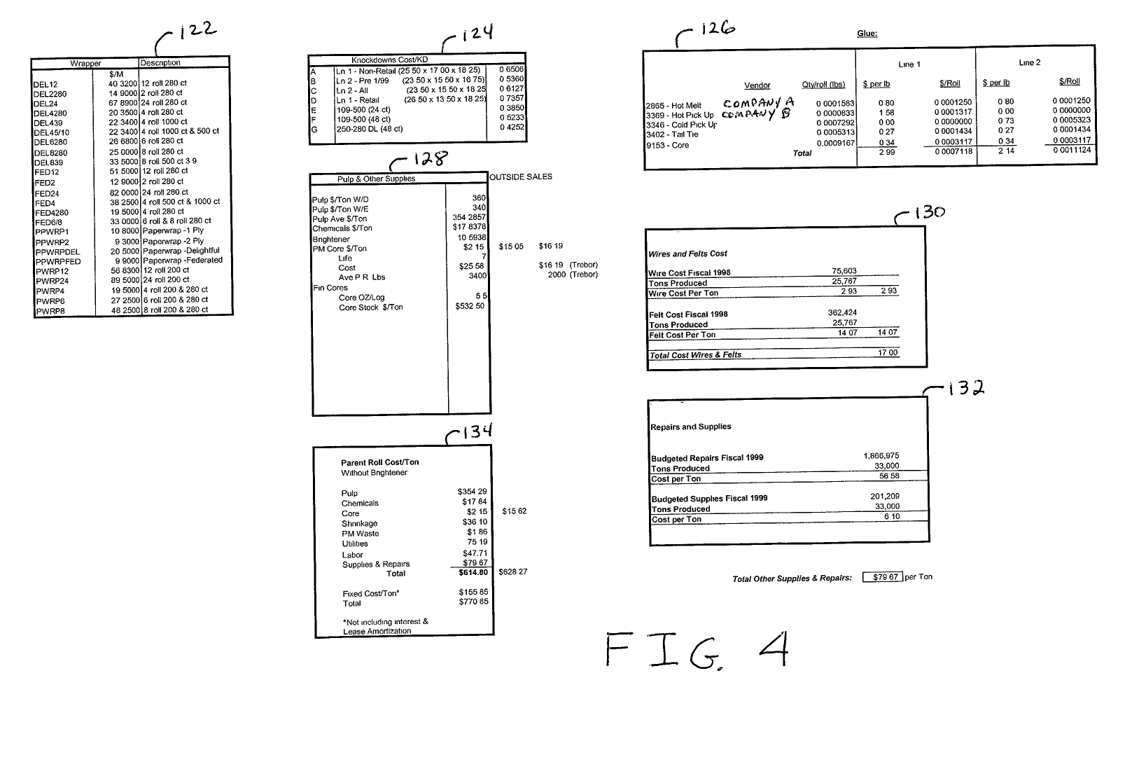

FIG. 4 is a spreadsheet 120 which documents supply costs in producing a companies' manufactured product lines. Spreadsheet 120 includes, for the paper company example, supplies such as a wrapper material ledger 122, a knockdowns ledger 124, a glue ledger 126, a pulp and other supplies ledger 128, a wire and felts ledger130, and a repairs and supplies ledger 132. In several of the ledgers described, supply costs are described in total costs and in cost per ton of paper product produced. Glue ledger 126 describes glue consumption in quantities of dollars per pound and dollars per roll of paper product for a production line.

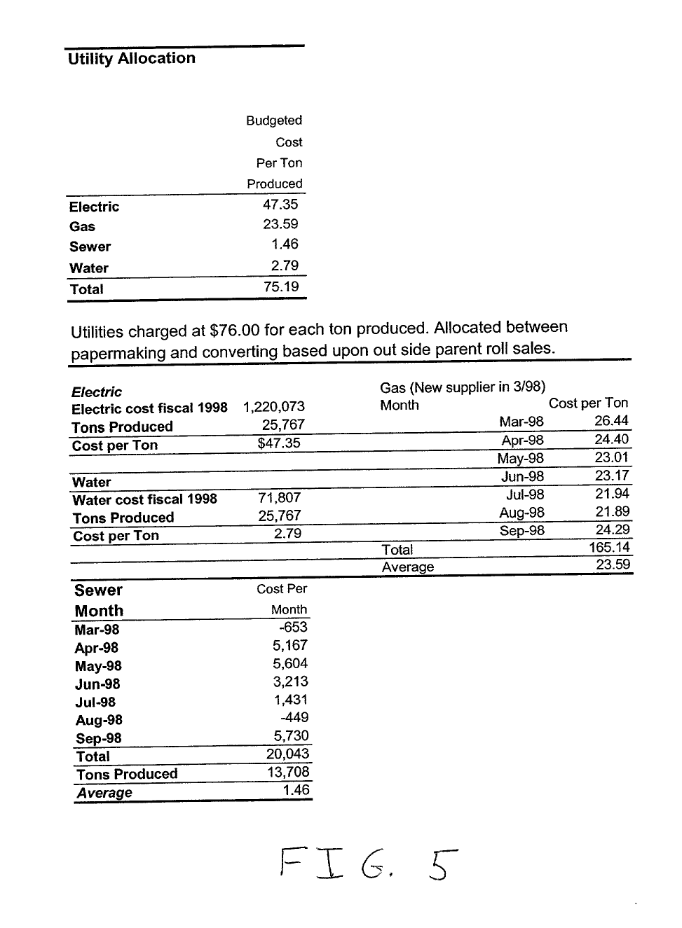

FIG. 5 is a spreadsheet 150 which details utility costs as a function of product production, again using the paper company example. Budgeted costs per ton of paper produced are estimates based on the prior years utility usage that has been totaled and averaged over the product produced for that year.

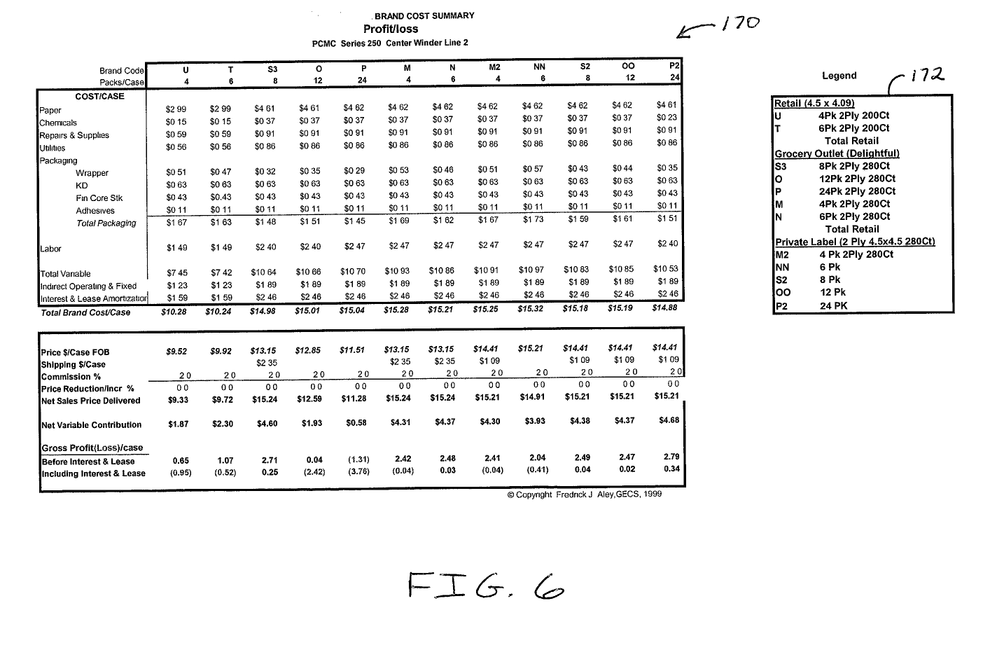

FIG. 6 is a spreadsheet 170 which utilizes data input into above described spreadsheets and determines profit and loss by product brand codes. For the paper company example, a cost per case of product is determined from a total of materials used, including packaging adding labor costs, indirect operating and fixed costs, and interest and lease amortization.

From a sales price, shipping costs are added and sales commissions are subtracted as are any price reductions to determine a net sales price of delivered product and a net variable contribution per case of product. Gross profits and losses per case of product are calculated both before interest and lease factors and also including interest and lease factors. A legend is included in spreadsheet 170 matching brand codes used with product descriptions.

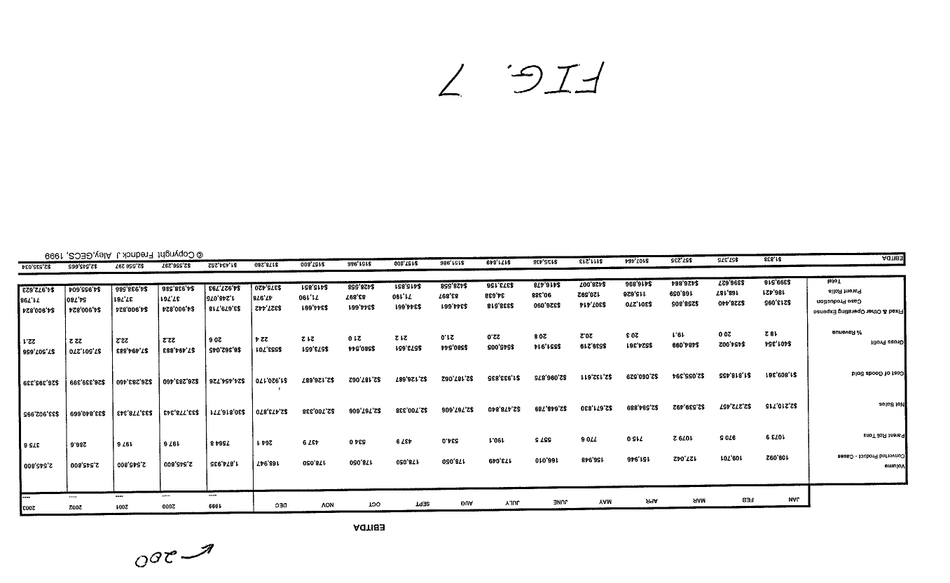

FIG. 7 is a spreadsheet 200 of Earnings Before Interest, Taxes, Depreciation or Amortization (EBITDA). Spreadsheet 200 uses a volume of product produced to determine net sales and a cost of goods sold. Net sales and cost of goods sold are used to determine a gross profit and gross profit as a percentage of revenue. Gross profit is reduced by fixed and other operating expenses to determine an EBITDA. EBITDA for future years is estimated in the same manner using knowledge of actual sales, costs and product volumes for a previous year.

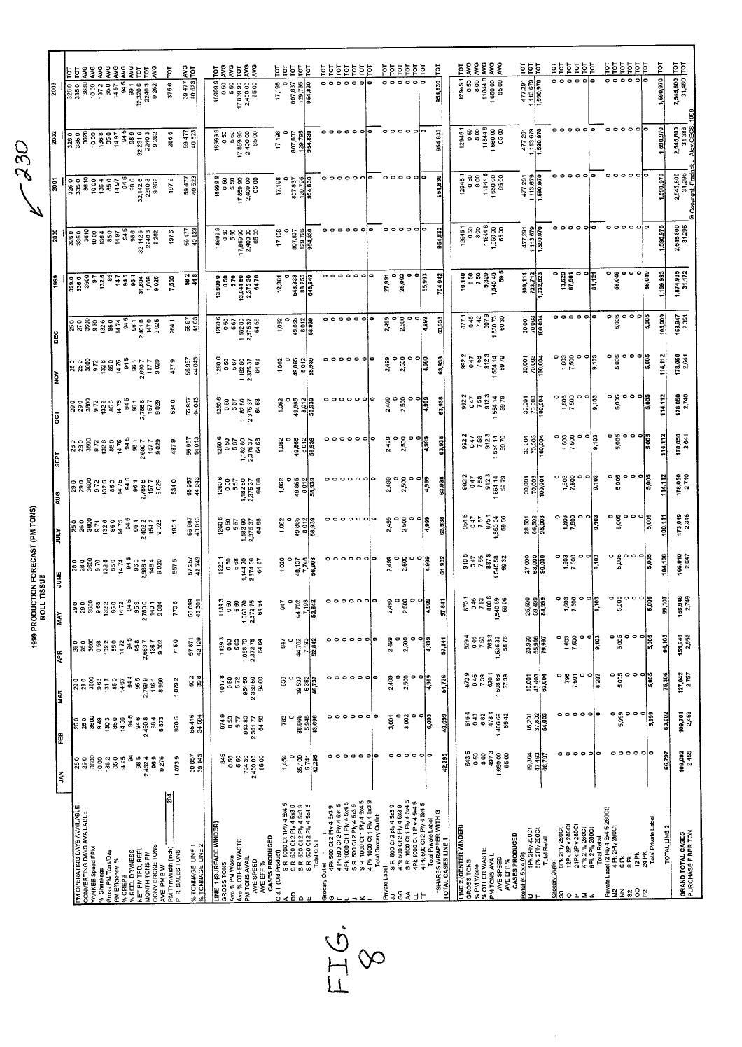

FIG. 8 is a spreadsheet 230 used to develop production forecasts. Production forecasts for the paper company example utilize user input for available production days and converting days, machine speed, efficiency and other product specific information. Spreadsheet is configured to then provide on a product specific basis production forecasts. Production forecasts for a first year are shown together with an additional number of years, still based on estimates that a user has input.

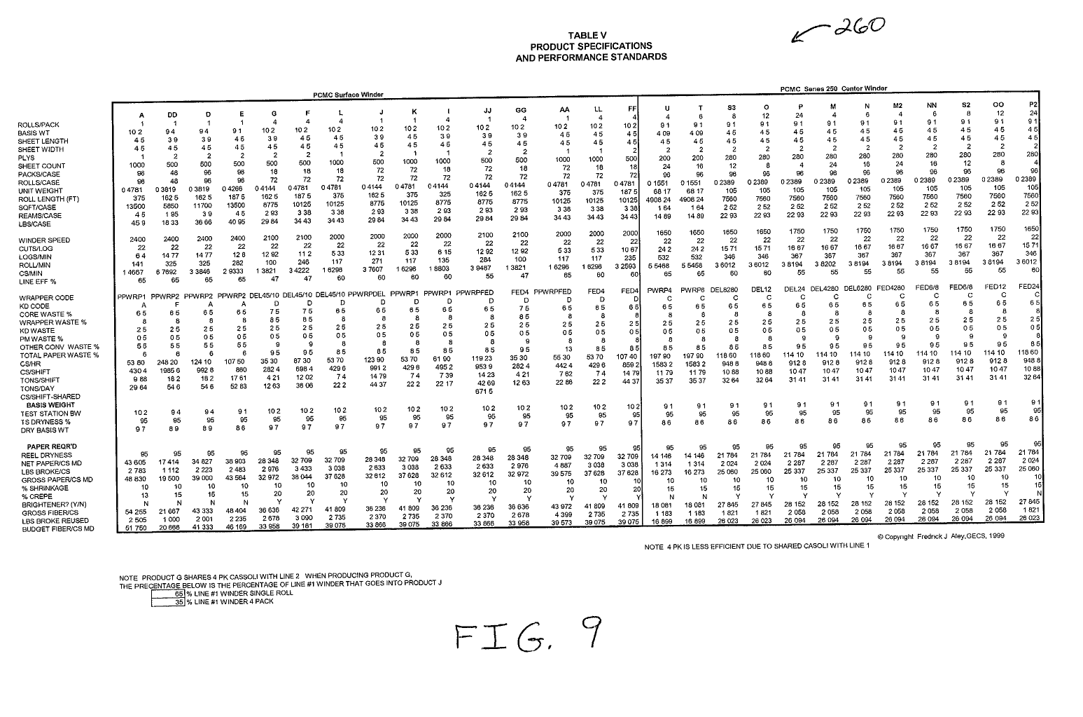

FIG. 9 is a spreadsheet 260 which contains product specifications and performance standards for each product line in the paper company example. Examples of specifications for a paper product include sheet width and length, plys, sheets/package, and packs per case. Inefficiencies are also taken into account, for example, wrapper waste and paper waste, all on a per product basis.

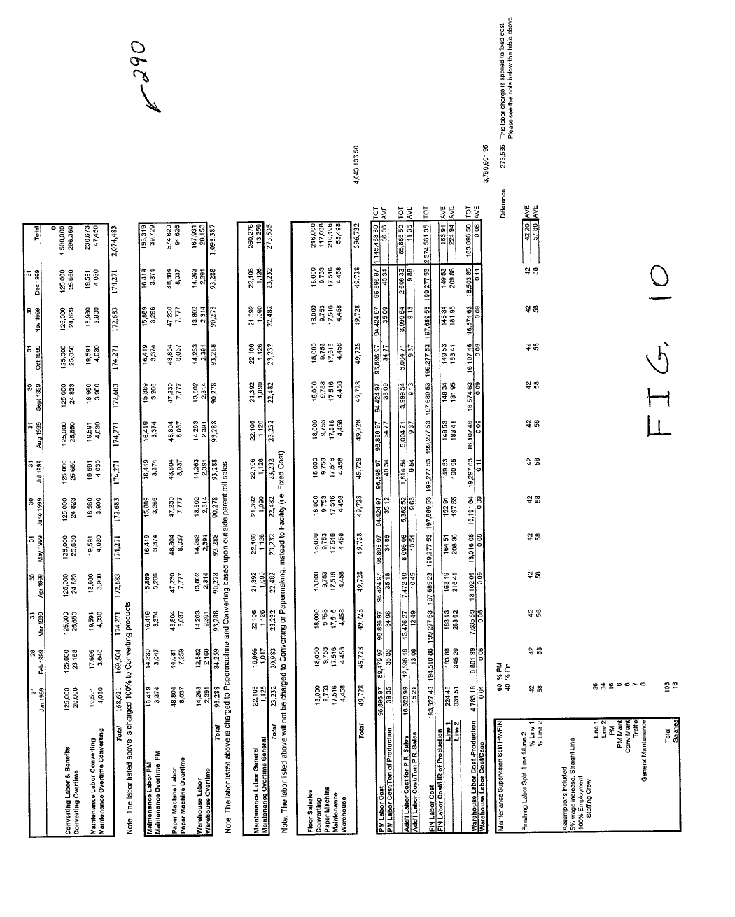

FIG. 10 is a spreadsheet 290 of labor costs. For the paper company example, labor cost indices include converting, maintenance, paper machine, and warehouse both for labor and benefits costs and for overtime costs. Based on entries into spreadsheet 290, labor costs per product are generated.

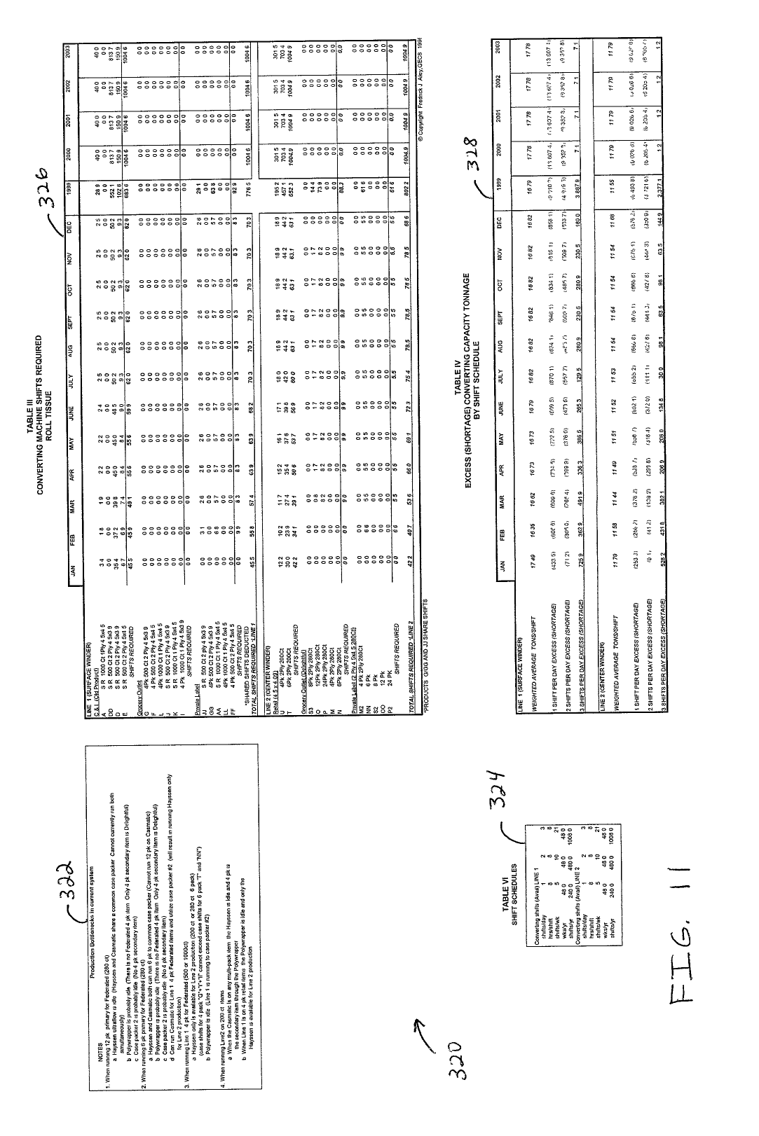

FIG. 11 is a spreadsheet 320 which includes notes 322 which describe bottlenecks in paper company production. For example, certain product may require common production machinery. Spreadsheet 320 also includes a table 324 of shift schedules available for individual production lines. A machine shifts table 326 in spreadsheet 320 shows the calculations of how many machine shifts are required to produce a product output based on production machine capacity and an amount of product needed to fulfill demand. Machine shifts table 326 is delineated by product line and includes estimate for additional years, based on estimated needs. Based on calculations in machine shifts table 326, a production capacity by shift table 328 is generated. Table 328 show, based on shifts/day and average product output/shift and excess or shortage of production capacity based on product demand forecasts. Table 328 helps planners determine how many shifts/day are required on one or more productions machines in order to meet product demands.

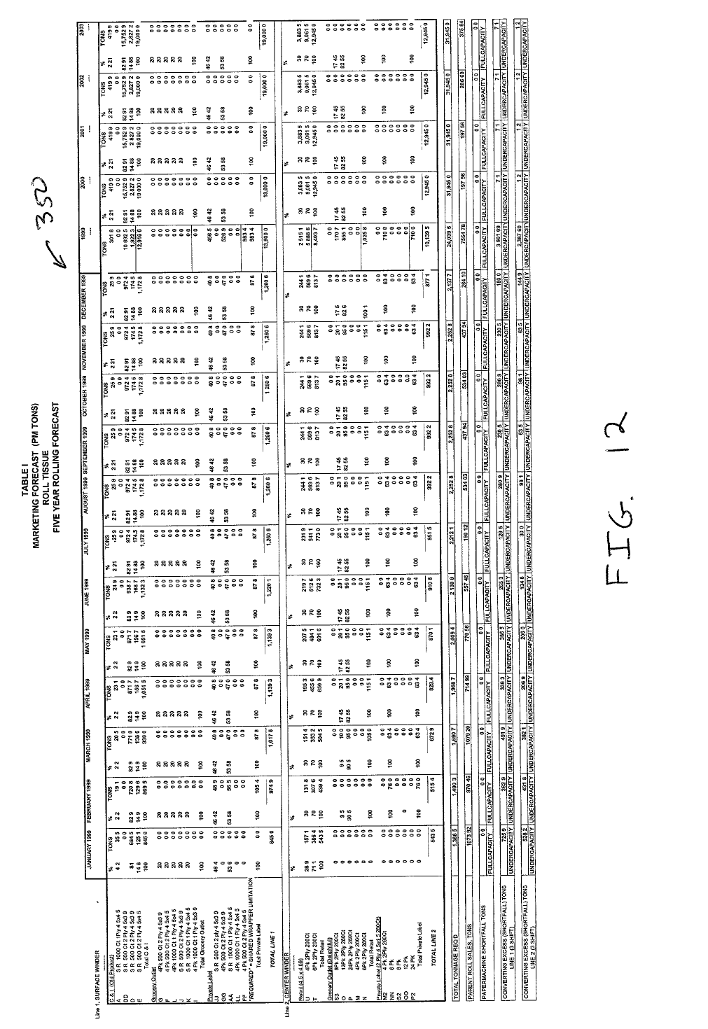

FIG. 12 is a rolling forecast spreadsheet 350 which shows per product outputs against machine capacities. Each product produced on a machine is entered as a percentage of machine capacity which generates a product output for that percentage of machine time. Machines are grouped into lines and a total output for each line is generated as are shortfalls and excesses for unit of time, including that year at hand and subsequent year forecasts.

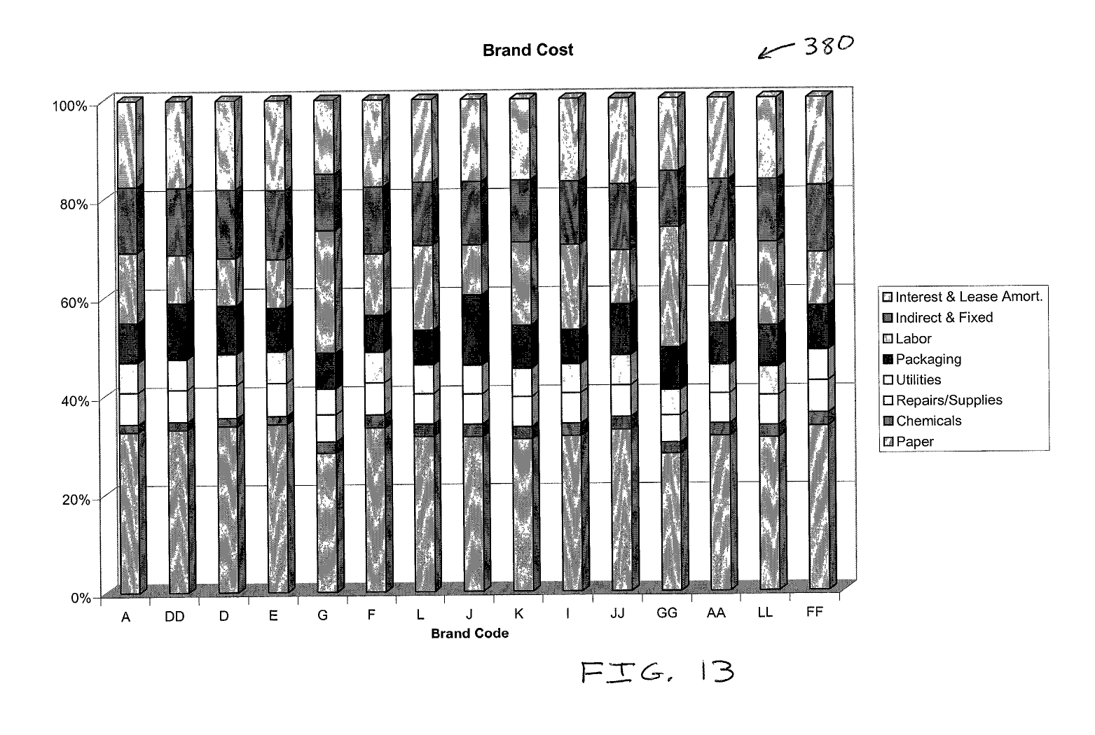

FIG. 13 is a graph 380 which a user of system 10 can generate to show product cost break down by percentages. For each product brand the paper company produces, product cost is graphed for paper, chemicals, repairs/supplies, utilities, packaging, labor, indirect and fixed costs and interest and lease amortization.

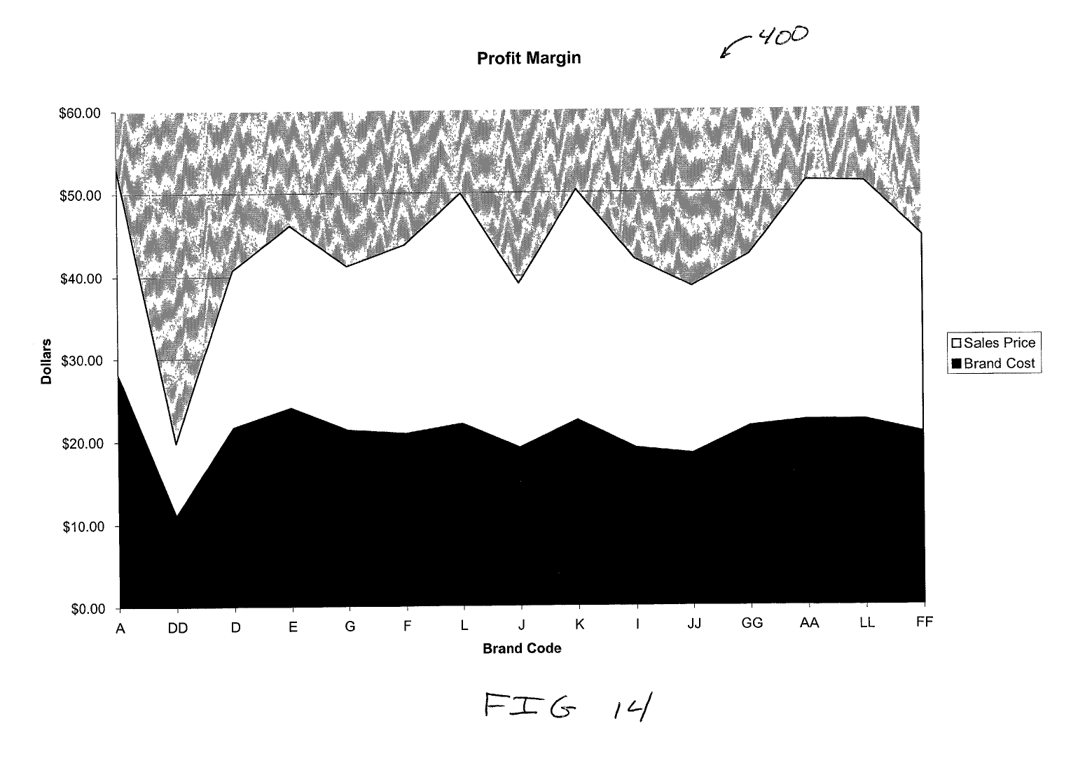

FIG. 14 is a graph 400 which a user of system 10 can generate to show product profit margin. For each product brand the paper company produces, product cost and product sales price is plotted.

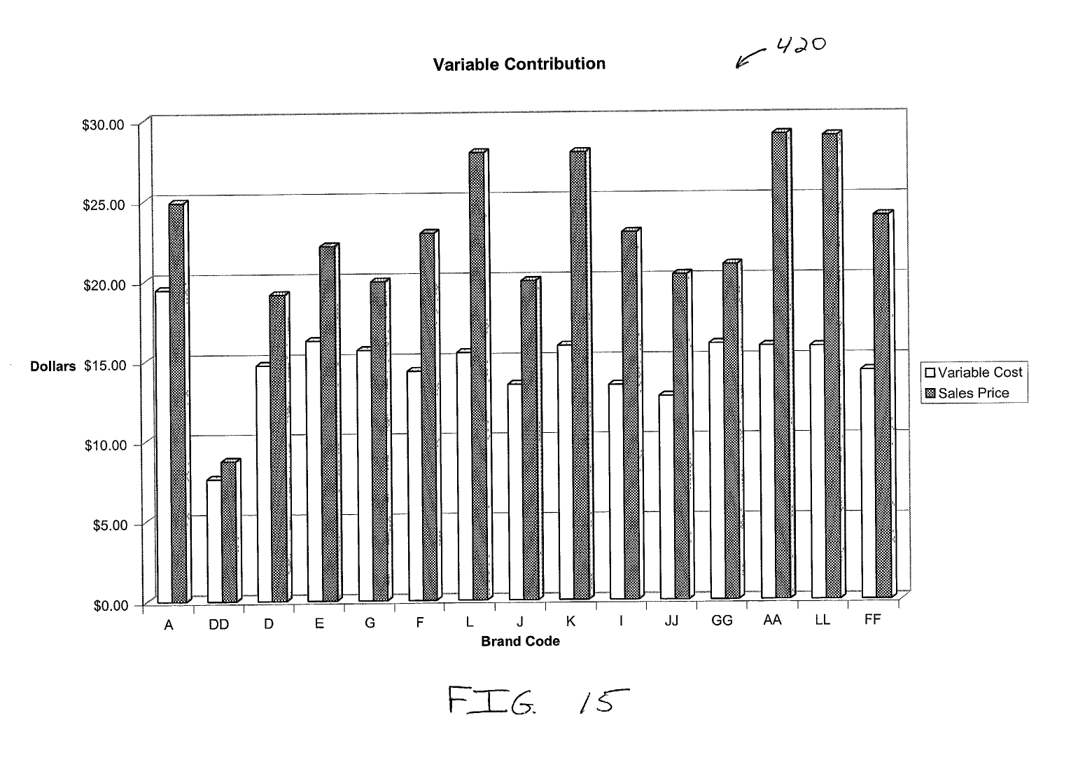

FIG. 15 is a graph 420 which a user of system 10 can generate to show variable contribution for each product brand. For each product brand the paper company produces, variable cost and product sales price is plotted.

As stated above, the preferred embodiment described herein, uses the paper industry as its example. However, the system and methods described herein are adaptable to any finance-production-marketing industrial environment for which various products or brands are produced. Each production line and major equipment is first analyzed for its design and actual capabilities under various production circumstances until its true capability is understood. Results of the analysis are reflected in the production analysis under various operating conditions. Production bottle-necks are also incorporated to reflect, and flag, conditions that are or may be created by changing marketing or production parameters. Significant flags include over capacity or under capacity situations and scheduling problems current or in the future based on the integrated analysis of all operating parameters and marketing forecasts. Other flags include equipment limitations and utilization factors also based on marketing forecasts and operating conditions.

The above described tool can be readily customized to accommodate new products or elimination of obsolete products. The tool also accommodates changes in production parameters such as product specifications, and production speed, efficiency and waste by production line. Promotion opportunities are also incorporated allowing the user to see the overall impact (profitability, EBITDA) of a short term or long term price reduction (by per-cent) or increase to any individual product.

While the invention has been described in terms of various specific embodiments, those skilled in the art will recognize that the invention can be practiced with modification within the spirit and scope of the claims.

What is claimed is:

1. A multi-year integrated marketing, production and financial system for use in a manufacturing business, said system comprising:
at least one computer;
a server configured with a plurality of spreadsheets to integrate a multi-year market forecast for all products produced with production specifications, production and performance parameters such as capacity, efficiency, waste levels, materials, utilities and labor cost, and production scheduling; and
a network interconnecting said server to said computers.

2. A system according to claim 1 wherein said server is further configured to determine at least one of per unit and per brand costing.

3. A system according to claim 2 wherein said server is further configured to determine at least one of per unit and per brand costing of materials.

4. A system according to claim 2 wherein said server is further configured to determine at least one of per unit and per brand costing of labor.

5. A system according to claim 2 wherein said server is further configured to determine at least one of per unit and per brand costing of utilities.

6. A system according to claim 2 wherein said server is further configured to determine at least one of per unit and per brand sales discounts, freight and commissions.

7. A system according to claim 1 wherein said server is further configured for input of operating expenses and fixed expenses for the business.

8. A system according to claim 7 wherein said server is further configured to automatically show impacts to Earnings Before Interest, Taxes, Depreciation and Amortization (EBITDA) as a result of any change to any parameter in marketing, finance, or production.

9. A system according to claim 1 wherein said server is configured to determine whether capacity for production is at capacity, below capacity, or above capacity using a scheduling analysis.

10. A system according to claim 1 wherein said server is configured to determine a production schedule based on labor constraints and production restraints.

11. A system according to claim 1 wherein said server is configured to notify a user of critical situations resulting from at least one of a marketing forecast, production schedule change, a product specification change and a change in production capability.

12. A system according to claim 1 wherein said server is configured to receive and store at least one of marketing data, production data, product data, pricing data and cost data.

13. A system according to claim 1 wherein said network is at least one of the Internet, an intranet, a local area network (LAN), a wide area network (WAN), dial-in-connections, cable modems and special high-speed ISDN lines.

14. A system according to claim 1 wherein said server is configured with a revision log incorporating a listing of all changes and revisions to said spreadsheets by date.

15. A method for producing multi-year forecasts for products produced in a manufacturing business using an integrated marketing-production-finance system, said method comprising the steps of:
uploading data relating to at least one of production specifications, production and performance parameters and production schedules for individual product lines; and
determining any changes to the forecasts based upon uploaded data.

16. A method according to claim 15 wherein said step of determining any changes to the forecasts further comprises the step of determining at least one of per unit and per brand costing.

17. A method according to claim 16 wherein said step of determining at least one of per unit and per brand costing further comprises the step of determining at least one of per unit and per brand costing of materials.

18. A method according to claim 16 wherein said step of determining at least one of per unit and per brand costing further comprises the step of determining at least one of per unit and per brand costing of labor.

19. A method according to claim 16 wherein said step of determining at least one of per unit and per brand costing further comprises the step of determining at least one of per unit and per brand costing of utilities.

20. A method according to claim 16 wherein said step of determining at least one of per unit and per brand costing further comprises the step of determining at least one of per unit and per brand sales discounts, freight and commissions.

21. A method according to claim 15 wherein said step of uploading data further comprises the step of uploading operating expenses and fixed expenses for the business.

22. A method according to claim 15 wherein said step of determining any changes to the forecasts further comprises the step of determining impacts to Earnings Before Interest, Taxes, Depreciation and Amortization (EBITDA) as a result of any change to any parameter in marketing, finance, or production.

23. A method according to claim 15 wherein said step of determining any changes to the forecasts further comprises the step of determining whether capacity for production is at capacity, below capacity, or above capacity using a scheduling analysis.

24. A method according to claim 15 wherein said step of determining any changes to the forecasts further comprises the step of determining a production schedule based on labor constraints and production restraints.

25. A method according to claim 15 further comprising the step of notifying a user of critical situations resulting from at least one of a marketing forecast, production schedule change, a product specification change and a change in production capability.

26. A method according to claim 15 wherein said step of uploading data further comprises the step of receiving and storing at least one of marketing data, production data, product data, pricing data and cost data.
